(19) United States
(12) Patent Application Publication
(10) Pub. No.: US 2005/0007008 A1
(43) Pub. Date: Jan. 13, 2005

(54) Panel for color CRT and method for manufacturing the same

(76) Inventor: Kyung Kyu Park, Gumi-si (KR)

Correspondence Address: BIRCH STEWART KOLASCH & BIRCH, PO BOX 747, FALLS CHURCH, VA, 22040-0747, US

(21) Appl. No.: 10/886,713

(22) Filed: Jul. 9, 2004

(30) Foreign Application Priority Data
Jul. 10, 2003 (KR) 10-2003-0046928

(51) Int. Cl. H01J 31/00

(52) U.S. Cl. 313/479; 313/477 R; 313/478

(57) ABSTRACT

A panel for a color cathode ray tube, on which an image is to be displayed and which has a phosphor screen formed on an inner surface thereof, is disclosed. The panel comprises a plurality of coating film layers formed on an outer surface of the panel. The outermost coating film layer among the plurality of coating film layers includes a fluorine-containing compound.

This Nonprovisional application claims priority under 35 U.S.C. § 119(a) on patent application No: 10-2003-0046928 filed in Korea on Jul. 10, 2003, the entire contents of which are hereby incorporated by reference.

### BACKGROUND OF THE INVENTION

1. Field of the Invention

The present invention relates to a panel for a color cathode ray tube (CRT) and a method for manufacturing the same, and more particularly, to a panel for a color cathode ray tube and a method for manufacturing the same, in which a fluoro-silane compound is coated on the outermost layer of an anti-static or anti-reflection film formed on an outer surface of the panel, to thereby form a film.

2. Description of the Background Art

FIG. 1 is a cross-sectional view illustrating a conventional color cathode ray tube.

As shown in FIG. 1, the conventional color cathode ray tube comprises a panel 1 having a front surface to which explosion preventing means is fixed, a funnel 2 fused to a rear end of the panel 1, a phosphor screen 4 formed by coating red, green and blue phosphors on an inner surface of the panel 1, an electron gun 11 inserted into a neck part of the funnel 2 to emit an electron beam 6, a deflection yoke 5 for deflecting the electron beam 6, and a shadow mask 3 positioned inward of the panel 1 and defined with a plurality of holes having a regular interval to allow passage of the electron beam 6 therethrough.

The cathode ray tube further comprises a frame 7 for fixing and supporting the shadow mask 3 to hold the shadow mask 3 at a predetermined distance from the inner surface of the panel 1, a spring 8 for connecting the frame 7 and the panel 1 with each other, an inner shield 9 for shielding the cathode ray tube to allow the cathode ray tube to be less influenced by geomagnetism, a reinforcing band 12 installed around a skirt part of the panel 1 to absorb external shock, and a magnet 13 for controlling a moving path of the electron beam 6 to allow the electron beam 6 to be precisely impinged on a desired phosphor to thereby prevent degradation of color purity.

Describing an operation of the color cathode ray tube constructed as mentioned above, if a voltage is applied to a stem pin, heat is applied to a cathode, and electrons are emitted from the heated cathode. The emitted electrons are controlled and accelerated by an electrode, and the accelerated electrons are focused by a main lens system.

The electron beam 6 formed by the electrons accelerated and focused in this way is deflected by the deflection yoke 5 to be scanned onto the entire panel 1. As the electron beam 6 passes through the shadow mask 3 installed in front of the panel 1 and impinges on the phosphors 4 coated on the inner surface of the panel 1, an image is created.

Generally, in the case of a cathode ray tube used for a monitor, since a person views the monitor at a short distance, it is necessary to maximally reduce generation of electron waves and reflection of external light from an outer surface of the panel.

Therefore, in the conventional art, as shown in FIG. 2, an anti-static (AS) layer 14 containing an antimony compound or an indium/tin oxide (ITO) conductor is formed on the outer surface of the panel 1 to suppress generation of electron waves and render an anti-static function. Also, an anti-reflection (AR) layer 15 containing a silica compound such as TEOS is formed on the anti-static layer 14 to minimize reflection of light. Further, an anti-glare (AG) layer 16 is formed on the anti-reflection layer 15 to effect diffused reflection of external light and thereby reduce reflection of external light.

However, these coating films formed on the outer surface of the panel cannot reliably maintain their original characteristics. Thus, upon conducting an environmental test, a stain is produced on an outer surface of the coating layers to degrade quality of the cathode ray tube, and a characteristic of a conductive film is changed with the lapse of time to increase resistance of the coating films.

### SUMMARY OF THE INVENTION

Accordingly, an object of the present invention is to solve at least the problems and disadvantages of the background art.

An object of the present invention is to provide a panel for a color cathode ray tube and a method for manufacturing the same, in which a compound containing fluorine having a water-repellent function is coated on the outermost coating film formed on an outer surface of the panel, to avoid oxidization of the coating film and prevent resistance of the coating film from being increased, thereby improving quality of the cathode ray tube.

Another object of the present invention is to provide a panel for a color cathode ray tube and a method for manufacturing the same, in which a characteristic of fluorine is used to decrease frictional force, thereby improving wear resistance.

To achieve the above objects, in one aspect of the present invention, there is provided a panel for a color cathode ray tube, on which an image is to be displayed and which has a phosphor screen formed on an inner surface thereof, the panel comprising: a plurality of coating film layers formed on an outer surface of the panel, wherein the outermost coating film layer among the plurality of coating film layers includes a fluorine-containing compound.

In another aspect of the present invention, there is also provided a panel for a color cathode ray tube, on which an image is to be displayed and which has a phosphor screen formed on an inner surface thereof, the panel comprising: a plurality of coating film layers formed on an outer surface of the panel, wherein the outermost coating film layer among the plurality of coating film layers includes a fluorine-containing compound, and the fluorine-containing compound constituting the outermost coating film layer has a hydrophobic group.

In still another aspect of the present invention, there is provided a method for manufacturing a panel for a color cathode ray tube, on which an image is to be displayed and which has a phosphor screen formed on an inner surface thereof, the method comprising the steps of: forming one or more coating films on an outer surface of the panel; and forming a fluorine-containing scale film on the outermost coating film of the one or more coating films.

### BRIEF DESCRIPTION OF THE DRAWINGS

The invention will be described in detail with reference to the following drawings in which like numerals refer to like elements.

FIG. 1 is a cross-sectional view illustrating a conventional color cathode ray tube.

FIG. 2 is a cross-sectional view illustrating a coating film formed on an outer surface of a panel for the conventional color cathode ray tube.

FIG. 3 is a partially enlarged cross-sectional view illustrating a scale film formed on the outermost layer of coating films formed on an outer surface of a panel in accordance with an embodiment of the present invention.

FIG. 4 is a flow chart illustrating a method for manufacturing a panel for a color cathode ray tube in accordance with another embodiment of the present invention.

FIG. 5 is a graph showing reflection rate characteristics of coating films formed on the outer surface of the panel.

FIG. 6 is a view explaining a relationship between a contact angle of a solid surface and a surface tension.

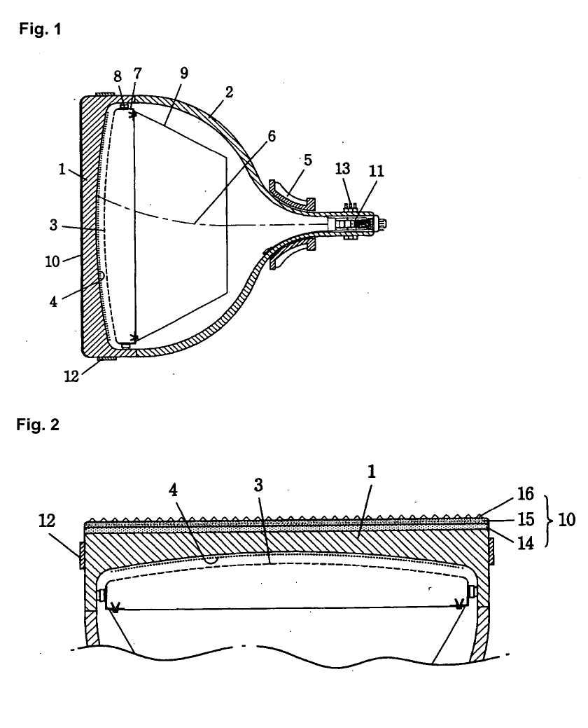

### DETAILED DESCRIPTION OF PREFERRED EMBODIMENTS

Preferred embodiments of the present invention will be described in a more detailed manner with reference to the drawings.

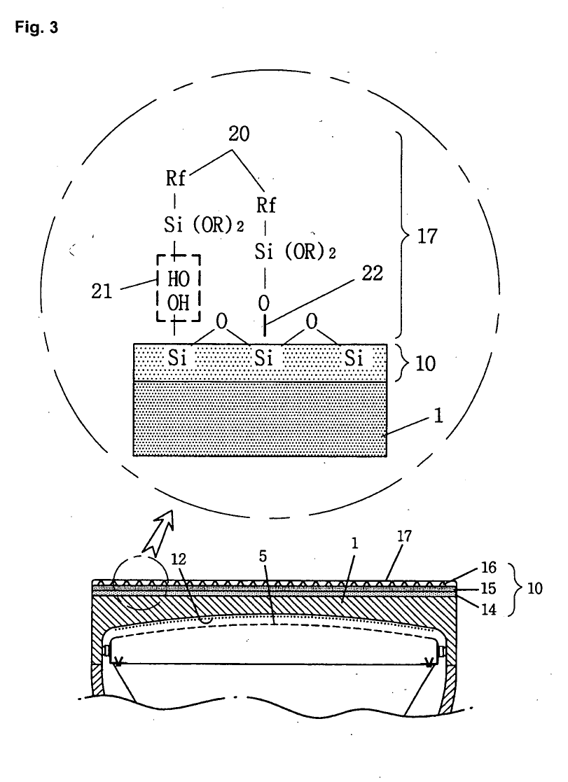

FIG. 3 is a partially enlarged cross-sectional view illustrating a scale film 17 formed on the outermost coating layer of a coating film combination 10 formed on an outer surface of a panel in accordance with an embodiment of the present invention.

As shown in FIG. 3, by appropriately treating a compound according to the present invention, the scale film 17 is formed on the outermost coating layer 16 of the coating film combination 10 formed on the outer surface of the panel 1. An inner surface of the scale film 17 forms a strong hydrogen bond 21 with the —OH group of the outermost coating layer 16 and a covalent bond 22 with Si of the coating film combination 10. And, an outer surface of the scale film 17 has a water-repellent fluorine group 20 exposed to the atmosphere.

Here, the composition of the scale film 17 according to the present invention comprises a compound containing the fluorine group 20, such as Fluoro(Rf)-CH₂CH₂Si(OCH₃)₃, as a main component. This compound is used in a main solvent of IPA with a concentration of 0.001 to 20 vol %.

The scale film 17 prevents air moisture from being introduced into the coating film, which in turn prevents resistance from being increased, a stain from being produced and a reflective film from being degraded, thereby maintaining an appropriate mechanical strength.

Also, a characteristic of fluorine is used to reduce frictional force to render slidability, improve scratch resistance of the coating film, and prevent an external contaminant from adhering to the coating film.

At this time, it is preferred that each coating film formed on the outer surface of the panel comprises at least one film selected among an anti-static (AS) film, an anti-reflection (AR) film and an anti-glare (AG) film.

Also, it is preferred that the outermost coating film including the fluorine-containing compound, serving as the scale film, has a contact angle in the range of 45° to 53° when measuring a water-repellent effect.

Further, it is more preferred that, when the plurality of coating film layers are formed on the outer surface of the panel, the outermost coating film layer among the plurality of coating film layers includes a fluorine-containing compound, and the fluorine-containing compound constituting the outermost coating film layer has a hydrophobic group.

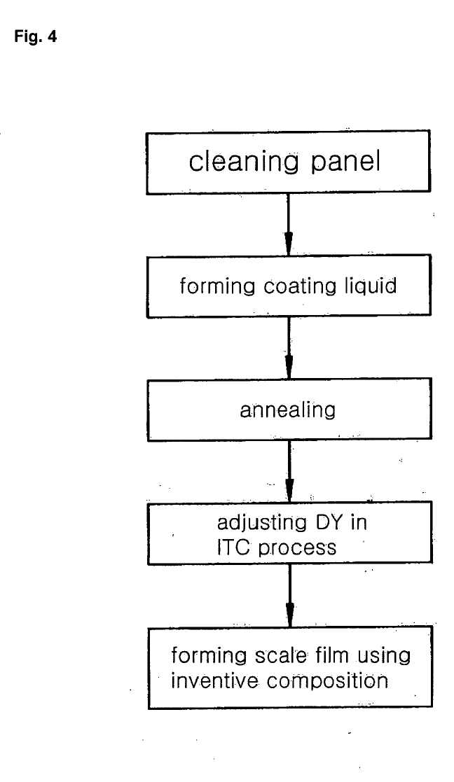

FIG. 4 is a flow chart illustrating a method for manufacturing the panel for a color cathode ray tube in accordance with another embodiment of the present invention.

As can be readily seen from FIG. 4, in the method for manufacturing the panel according to the present invention, a surface of a panel is cleaned and then pre-heated to a predetermined temperature. Thereafter, anti-static and anti-reflection compositions are coated on the surface of the panel by the conventional spin or spray coating process to form desired coating films thereon. Then, after the conventional color cathode ray tube manufacturing procedure is completed, before a protective sheet is attached to the surface of the panel, a scale film is formed on the outermost coating layer of the coating film combination, using the inventive compound.

At this time, besides the conventional spin or spray coating process, in order to form the scale film, a gauze can be smeared with the inventive compound and wiped off against the outer surface of the panel, so that water-repellent and resistance characteristics can be improved.

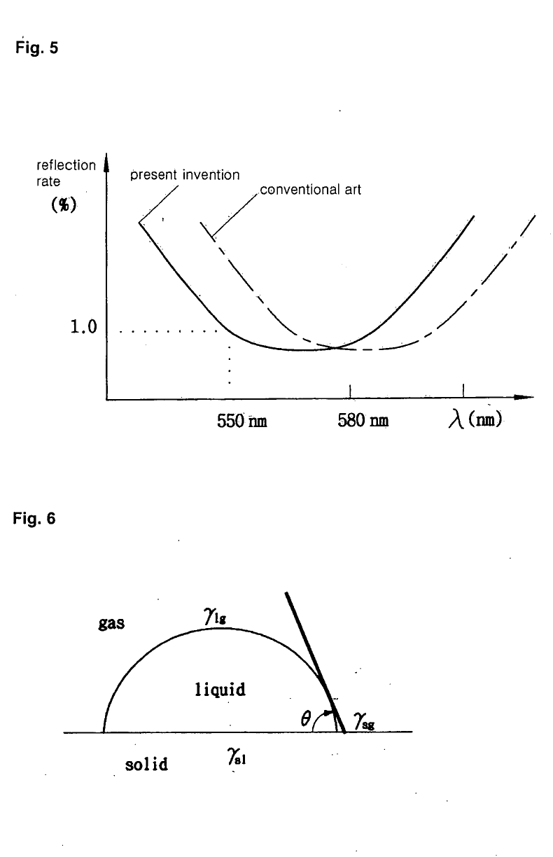

Hereafter, working effects of the panel for a color cathode ray tube according to the present invention will be described with reference to Tables 1 through 4 and FIGS. 5 and 6.

Referring to Table 1, there are given film hardness measurements of the conventional coating film combination and the present coating film combination on the outermost coating layer of which the scale film is formed using the fluorine-containing compound, the measurements being obtained using a micro scratch tester (MST).

As the fluorine-containing compound according to the present invention, Heptadecafluorodecyl-trimetoxysilane was used by way of example, which has a molecular formula of SiC₁₃F₁₇O₁₃, a molecular weight of 568.1 and a molecular structure formula of CF₃(CF₂)₇CH₂CH₂Si(OCH₃)₃.

TABLE 1

| | First | Second | |
|---|---|---|---|
| Example | conventional art | conventional art | Present invention |
| 1 | 7.78N | 8.12N | 8.9N |
| 2 | 7.68N | 8.06N | 8.86N |
| 3 | 7.71N | 8.10N | 9.05N |

From Table 1, it is to be readily understood that hardness measurements of the coating film combination processed using the inventive composition are larger than those of the conventional coating film combination.

FIG. 5 is a graph showing reflection rate characteristics of coating films formed on the outer surface of the panel.

As can be readily seen from FIG. 5, in the case of the present invention, since a reflection rate is reduced over a visible region, the reflection characteristic is significantly improved. In general, if a reflection rate is no greater than 1.0%, glaring does not occur when a person views a monitor.

In Table 2, there are given results obtained by implementing a rubbing process for the purpose of measuring slidability of the conventional coating film combination and the present coating film combination on the outermost coating layer of which the scale film is formed using the inventive composition.

TABLE 2

| | | Present | | | |
|---|---|---|---|---|---|
| | | invention (using | | | |
| | | the inventive | | Conventional | |
| | | composition) | | art | |
| | Before | Before | Differ- | Before | Differ- |
| Example | experiment | experiment | ence | experiment | ence |
| 1 | 8.2 | 9.5 | 16% | 9.8 | 20% |
| 2 | 8.3 | 10 | 20% | 10.7 | 29% |
| 3 | 8.5 | 9.8 | 15% | 10.5 | 24% |
| Average | 8.3 | 9.8 | 17% | 10.3 | 24% |
| rate of | | | | | |
| change | | | | | |

While the experiments are performed to measure slidability of the conventional and present coating film combinations, a person skilled in the art will readily recognize that the results appearing on Table 2 represent adhesion characteristics between the panel and coating film combination.

In Table 2, by observing the statistical significant differences with respect to the adhesion characteristics between the panel and coating film combination, it is to be noted that about 10% statistically significant difference is occurred upon performing experiments. As a consequence, it is to be readily understood that adhesion force of the present panel is more excellent than that of the conventional art, which is not coated with the composition of the present invention.

In Table 3, there are given water-repellent characteristic comparison results between the conventional panel and the present panel processed with the inventive composition.

TABLE 3

| | | Example | | |
|---|---|---|---|---|
| | | (contact angle) | | |
| Classification | Kind of sample | 1 | 2 | 3 |
| Conventional | Panel glass | 30° | 32° | 34° |
| Art | Panel glass + Coating film | 34° | 35° | 38° |
| Present invention | Panel glass + Coating film + | 45° | 49° | 53° |
| | Processing with composition | | | |

In Table 3, water repellent characteristics are related with surface tension characteristics obtained by dropping water on a solid surface.

FIG. 6 is a view explaining a relationship between a contact angle of a solid surface and a surface tension. Referring to FIG. 6, a contact angle can be denoted as given in the following mathematical expression:

$$θ = {cos}^{- 1} ( \frac{γ s , g - γ s , l}{γ l , g} )$$

where θ is a contact angle, γs,g is a free energy of a solid surface, γs,l is a boundary tension between liquid and solid, and γl,g is a surface tension of liquid.

In the above mathematical expression, if a surface tension is small, since an area over which liquid used for measuring a surface tension is spread is increased, the value of θ is decreased. Hence, the more the value of θ is decreased, the more a surface tension is decreased.

Using this theory, by measuring contact angles after surface-treating the outermost coating layer of the panel with the inventive compound, it was found that a contact angle in the case of the present coating film is larger than that of the conventional coating film.

That is to say, as a contact angle between the coating film of the panel and water is increased as can be readily seen from Table 3, in the case of the present invention, it is difficult of air moisture to be introduced into the coating film.

In Table 4, there are given resistance characteristics of the conventional coating film combination and the present coating film combination on the outermost coating layer of which the scale film is formed using the inventive composition, which are measured with the lapse of time.

TABLE 4

| | Conventional art | | Present invention | |
|---|---|---|---|---|
| | (not processed) | | (processed) | |
| | Initial | | Initial | |
| | resistance | With the lapse | resistance | With the lapse |
| Example | (Ω) | of time | (Ω) | of time |
| 1 | 16.6 | 23.6 | 33.7 | 39.0 |
| 2 | 23.5 | 36.3 | 18.6 | 20.6 |
| 3 | 31.8 | 47.2 | 25.8 | 28.6 |

| | | |
|---|---|---|
| Average | 48% | 12% |
| change rate | | |

It can be seen from Table 4 that, when compared to the conventional art, in the case of the present invention, it is possible to minimize an increase in resistance with the lapse of time by preventing the coating film combination from being oxidized by air moisture, with the aid of the water-repellent function.

As apparent from the above description, the present invention provides advantages in that a compound containing fluorine having a water-repellent function is coated on the outermost coating film formed on an outer surface of the panel, whereby a stain is not produced on an outer surface of a coating film upon conducting an environmental test and oxidization of the coating film is prevented, thereby minimizing an increase in resistance and improving quality of a cathode ray tube.

Also, in the present invention, a characteristic of fluorine is used in such a way as to decrease frictional force, whereby wear resistance is improved.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A panel for a color cathode ray tube, on which an image is to be displayed and which has a phosphor screen formed on an inner surface thereof, the panel comprising:
a plurality of coating film layers formed on an outer surface of the panel,
wherein the outermost coating film layer among the plurality of coating film layers includes a fluorine-containing compound.

2. The panel of claim 1, wherein each coating film formed on the outer surface of the panel comprises at least one film selected from an anti-static film, an anti-reflection film and an anti-glare film.

3. The panel of claim 1, wherein the fluorine-containing compound forms hydrogen and covalent bonds with the coating film.

4. The panel of claim 1, wherein the fluorine-containing compound has a structure of Fluoro(Rf)-CH₂CH₂Si(OCH₃)₃.

5. The panel of claim 1, wherein the outermost coating film including the fluorine-containing compound, serving as a scale film, has a contact angle in the range of 45° to 53° when measuring a water-repellent effect.

6. The panel of claim 1, wherein the outer surface of the panel is substantially flat.

7. A panel for a color cathode ray tube, on which an image is to be displayed and which has a phosphor screen formed on an inner surface thereof, the panel comprising:
a plurality of coating film layers formed on an outer surface of the panel,
wherein the outermost coating film layer among the plurality of coating film layers includes a fluorine-containing compound, and the fluorine-containing compound constituting the outermost coating film layer has a hydrophobic group.

8. The panel of claim 7, wherein each coating film formed on the outer surface of the panel comprises at least one film selected from an anti-static film, an anti-reflection film and an anti-glare film.

9. The panel of claim 7, wherein the fluorine-containing compound forms hydrogen and covalent bonds with the coating film.

10. The panel of claim 7, wherein the fluorine-containing compound has a structure of Fluoro(Rf)-CH₂CH₂Si(OCH₃)₃.

11. The panel of claim 7, wherein the outermost coating film including the fluorine-containing compound, serving as a scale film, has a contact angle in the range of 45° to 53° when measuring a water-repellent effect.

12. The panel of claim 7, wherein the outer surface of the panel is substantially flat.

13. A method for manufacturing a panel for a color cathode ray tube, on which an image is to be displayed and which has a phosphor screen formed on an inner surface thereof, the method comprising the steps of:
forming one or more coating films on an outer surface of the panel; and
forming a fluorine-containing scale film on the outermost coating film of the one or more coating films.

14. The method of claim 13, wherein the one or more coating films are formed to serve as an anti-static film, an anti-reflection film and an anti-glare film.
